(19) United States
(12) Patent Application Publication
(10) Pub. No.: US 2026/0264719 A1
(43) Pub. Date: Sep. 10, 2026

(54) DETERMINING DRIVING PATTERNS BASED ON MIXED REAL-WORLD AND SIMULATED SCENARIOS FOR AUTONMOUS DRIVING

(71) Applicant: AUTOBRAINS TECHNOLOGIES LTD, Tel Aviv-Yafo (IL)

(72) Inventor: Igal RAICHELGAUZ, Tel Aviv (IL)

(73) Assignee: AUTOBRAINS TECHNOLOGIES LTD, Tel Aviv-Yafo (IL)

(21) Appl. No.: 19/074,498

(22) Filed: Mar. 10, 2025

Related U.S. Application Data
(63) Continuation of application No. 19/074,492, filed on Mar. 10, 2025.

(51) Int. Cl. B60W 60/00

(52) U.S. Cl. CPC B60W 60/0027; B60W 2554/4046

(57) ABSTRACT

A method for determining driving patterns for mixed real-world and simulated scenarios for autonomous driving, the method includes determining, based on sensed information, an actual situation faced by the vehicle; analyzing, by using a machine learning process in real-time during inference, the actual situation sensed information across a set of multiple reference situations, by searching in a database holding for each reference situation out of the multiple reference situations, reference situation information comprising behavioral information pertaining to road players during the situation, wherein database is built based on simulated aerial information pertaining to simulated road players in multiple situations; identifying, based on the analyzing, one or more matching reference situations of the multiple reference situations that correspond to the actual situation; determining a driving pattern, based on the identifying; and providing the driving pattern, for use in autonomous driving of the vehicle.

### BACKGROUND

Artificial intelligence models for driving require vast amount of training information.

Gathering training information by using ground vehicle images is time consuming and may require to cover vast regions in order to catch edge cases.

There is a growing need to speed up the gathering of training information for scaling up the training of artificial intelligence models for autonomous driving, without relying on vast amounts of vehicles for sensing and collecting information.

### SUMMARY

There is provided a method, a non-transitory computer readable medium and a system as illustrated in the application.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a computerized system;

FIG. 2 illustrates an example of a vehicle;

FIG. 3A illustrates an example of a method;

FIG. 3B illustrates an example of a method;

FIG. 4A. 4B, 4C and 4D illustrate examples of sensed aerial information and augmented aerial information unit;

FIG. 5A illustrates an example of a method;

FIG. 5B illustrates an example of a method;

FIG. 5C illustrates an example of a method; and

FIG. 6 illustrates an example of a method.

### DETAILED DESCRIPTION

The different figures illustrates examples of units and/or software and/or information items and/or steps and/or components. These examples are provided for brevity of explanation. At least one of the units and/or software and/or information items and/or steps and/or components is optional or mandatory.

The term obtaining include receiving and/or generating.

Artificial intelligence is used in relation to machines that mimic human intelligence and human cognitive functions like learning and problem solving. There are three types of artificial intelligence that include artificial super intelligence, artificial narrow intelligence and artificial general intelligence. Machine learning is a subset of artificial intelligence that allows for optimization. Deep machine learning is a subset of machine learning that uses larger datasets for training and learns in a different manner than not deep machine learning.

Neural networks are a subset of machine learning and are used for implementing deep learning.

Any reference in the application to any of the terms “artificial intelligence”, “machine learning”, “deep learning” or “neural network” should be applied mutatis mutandis to any other term of “artificial intelligence”, “machine learning”, “deep learning” or “neural network”. For example—any reference to a neural network should be applied mutatis mutandis to artificial intelligence and/or should be applied mutatis mutandis to “machine learning”, and/or should be applied mutatis mutandis to “deep learning”.

Any reference to information should be applied mutatis mutandis to one or more parts of the information. The information may be aerial information, training information, behavioral information, and/or other source, or type of information.

According to an embodiment aerial information from the aerial sensor, captured by an aerial system or aerial vehicle such as a drone, may be processed or pre-processed to include selective, or partial information, or to include additional information fused together with the aerial information, used in producing training information for training of artificial intelligence models, machine learning processes, and neural networks, for autonomous driving, to sharing, and to development and implementation of other enhancements pertaining to various applications of autonomous driving.

According to an embodiment the aerial information is augmented.

According to an embodiment the aerial image is augmented based on simulation. In order to increase the reliability of the augmentation, the simulation is generated based on real-world acquired information.

According to an embodiment the augmentation allows to train and test skills on a more granular and comprehensive narrow data (for example per road segment and per scenario), covering real-world edge cases.

According to an embodiment the usage of augmented aerial information provides more information per region than the non-augmented aerial information—and this may reduce the need in real time coverage for acquiring training information. For example—augmented aerial information regarding a region can be augmented to include scenarios that were captured in other regions.

According to an embodiment, the method includes
Collecting real-world aerial information per road segment and scenario (transformed into multiple ego vehicles and their perspectives)
For every road segment and scenarios learning the traffic patterns, drivers profiling, road players' behaviors
Augmenting the aerial information with real-world simulated road players (other vehicles, pedestrians, cyclists, animals)—by simulating real road players, and their trajectory in the same/very similar environment (road segment & scenario).
Generalizing the stored dynamic scenarios. The generalizing includes combining information related to similar scenarios, building training datasets for the “combined” similar driving scenarios.

According to an embodiment, the augmented aerial information is used to train skills and get higher robustness for edge cases.

According to an embodiment, the augmented aerial information is used to test existing AI models for Autonomous driving.

According to an embodiment, the augmented aerial information is used for applying a “play button” mode (inference, real-time autonomous driving)—identification of a current road segment and scenario, predicting trajectories of different road players (real/simulated) and imitating (“playing”) the driving of closest safe driver experiencing the same situation (from the same point of view).

According to an embodiment, in different scenarios and road segments, the augmented aerial information is used to train a model for safe driving.

According to an embodiment a safe driving criteria can be determined by a set of parameters, e.g., obeying traffic rules, no sudden emergency braking.

According to an embodiment, a matching to a safe driver is done using signatures: matching the signatures of the current scenario against a database of signatures of all dynamic scenarios to find the safe driving at a given scenario.

According to an embodiment, the augmented aerial information is used for prediction in an ego vehicle's perspective.

According to an embodiment, the prediction is in accordance with the time of day, weather and traffic.

Examples:
Training an artificial intelligence model to imitate, in school zone a driver that travels the same direction as the ego vehicle and behaves as if a virtual child suddenly crosses between parked cars, in a certain hour.
Training an artificial intelligence model to imitate a driver that slowly decelerates as a result of a virtual animal crossing in the specific road segment in the highway at night hours.
Training an artificial intelligence model to imitate a driver that observed a virtual cyclist coming from the right and about to make a sudden left turn in a certain intersection in the city

According to an embodiment, the aerial information includes comparing behaviors of different vehicles that face the same driving situation to provide comparison results, with respect to the driving of a particular vehicle. The comparison results may be used to generate augmented aerial information, to verify behavioral information regarding different vehicles, identify behavioral information outliers to be ignored with respect to the driving of a particular vehicle, generate statistical information regarding behavioral information with respect to a particular vehicle, and the like.

According to an embodiment, the training information is used for training one or more artificial intelligence models—such as but not limited to artificial intelligence models, implementing rule-based models and/or neural network, for autonomous driving.

An artificial intelligence model for driving may be used in relation to generating and/or requesting and/or determining and/or instructing and/or triggering and/or controlling and/or transmitting and/or outputting and/or preforming at least one autonomous or non-autonomous driving related operation is associated with the artificial intelligence models below a maturity level, and/or driving along the path—for example in compliant with one or more levels of autonomous driving—such as L2, L2+, L2++, L3 or L4 autonomous driving.

According to an embodiment, the training information is used for training any number of artificial intelligence models—such as more than 10, 100, 1,000, 10,000, 100,000,1,000,000, 10,000,000 and the like.

According to an embodiment, the training information is provided at one or more granularities—for example at least a part of the training information is vehicle manufacturer specific and/or vehicle instance specific, and/or vehicle year of manufacturing specific, or vehicle type specific (for example 2 wheel vehicle, 4 wheel vehicle, more than 4 wheel vehicle, van, bus, truck, motorcycle), or just be provided at a general vehicle granularity.

According to an embodiment, different artificial intelligence modes are associated with one or more granularity of training information. For example one or more artificial intelligence models are associated with general vehicles while one or more other artificial intelligence models are associated with a certain vehicle instance and/or a certain vehicle type, and the like.

According to an embodiment, the training of the one or more artificial intelligence models may be of any type of training—supervised, unsupervised, semi-supervised learning, reinforcement learning, and the like.

Accordingly—any of the artificial intelligence models may related to of the mentioned above examples of artificial intelligence.

According to an embodiment, the method includes gathering training information for training artificial intelligence models for use in driving based on AIUs that capture, concurrently or during short acquisition periods, information regarding behaviors of a large number of road users—such as vehicles, animals, pedestrians, cyclists—when facing one or more identified driving scenario.

According to an embodiment, the method includes obtaining aerial information that includes AIUs that capture, concurrently or during short acquisition periods, information regarding behaviors of a large number of road users—such as vehicles.

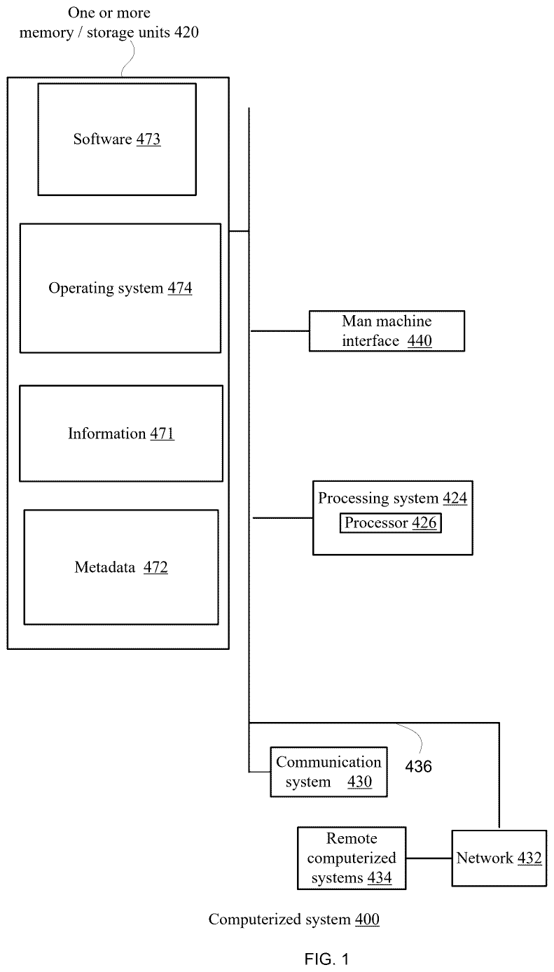

FIG. 1 illustrates an example of a computerized system 400.

Computerized system 400 includes a man machine interface 440 having or being in communication with man machine interface (MMI) controller (not shown), a communication system 430, one or more memory and/or storage units 420, a processing system 424 including processor 426. The computerized system may be a server, a laptop, a desktop or any other computer and may include or be in communication with a sensing unit and/or a controller.

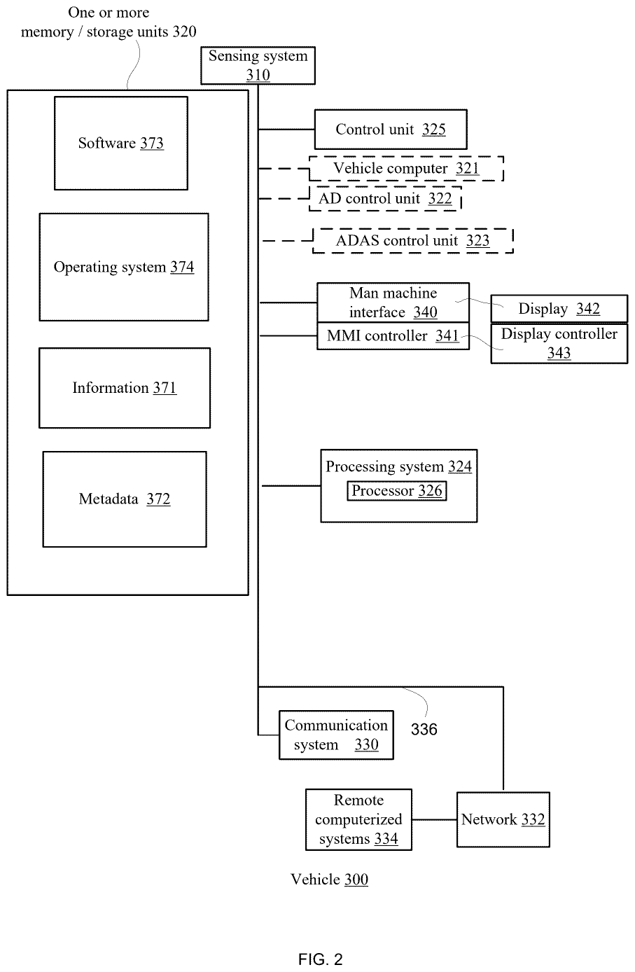

According to an embodiment, computerized system 400 is in communication with network 432 and one or more other remote computerized systems 434 that are in communication with network 432. An example of a remote computerized system is a vehicle (such as vehicle 300 of FIG. 2), a server or one or more computers having access to a storage system.

The memory and/or storage units 420 was shown as storing software. Any reference to software should be applied mutatis mutandis to code and/or firmware and/or instructions and/or commands, and the like.

Processor 426 includes a plurality of processing units 426(1)-426(J), J is an integer that exceeds one. Any reference to one unit or item should be applied mutatis mutandis to multiple units or items. For example—any reference to processor should be applied mutatis mutandis to multiple processors, any reference to communication system 430 should be applied mutatis mutandis to multiple communication systems.

According to an embodiment, the memory and/or storage units 420 stores at least one of: operating system 474, information 471, metadata 472, and software 473.

According to an embodiment, processing system 424 is configured to perform any method illustrated in the application while executing software.

FIG. 2 illustrates an example of vehicle 300 configured to utilize the set of artificial intelligence models during inference.

Vehicle 300 includes a man machine interface 340 having or being in communication with man machine interface (MMI) controller 341, wherein in FIG. 1 the MMI is a display 342 or includes a display 342 and the MMI controller is a display controller 343 or includes the display controller 343, a communication system 330, one or more memory and/or storage units 320, a processing system 324 including processor 326. The communication system 330, the one or more memory and/or storage units 320, and the processing system 324 may belong to a computerized system of vehicle 300. The computerized system may be a server, a laptop, a desktop or any other computer and may include or be in communication with a sensing unit and/or a controller.

According to an embodiment, vehicle 300 is in communication with network 332 and one or more other remote computerized systems 334 that are in communication with network 332. An example of a remote computerized system is a server or one or more computers having access to a storage system that stores items related to one or more portions of one or more groups of neural networks—at least some of which are not currently stored in the vehicle.

According to an embodiment, the memory and/or storage unit 320 stores at least one of: operating system 374, information 371, metadata 372, and software 373.

The control unit 325 may cooperate with ADAS control unit 323 and/or with AD control unit 322 and/or may control or communicate with other vehicle components—including vehicle computer.

The ADAS control unit 323 is configured to control ADAS operations.

The AD control unit 322 is configured to control autonomous driving of the autonomous vehicle.

The vehicle computer 321 is configured to control the operation of the vehicle—especially controlling the engine, the transmission, and any other vehicle system or component.

The vehicle computer 321 may be in communication with an engine control module, a transmission control module, a powertrain control module, and the like.

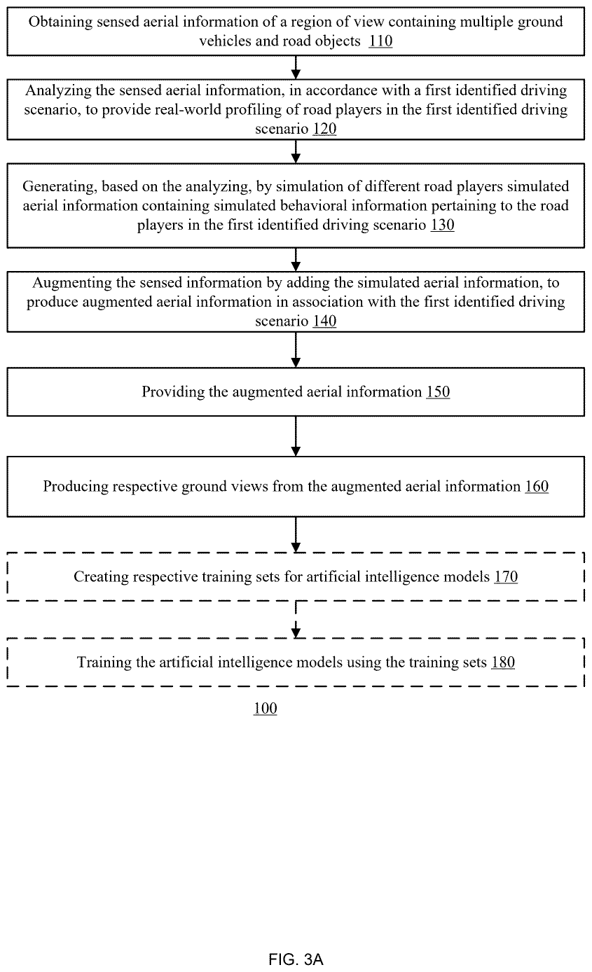

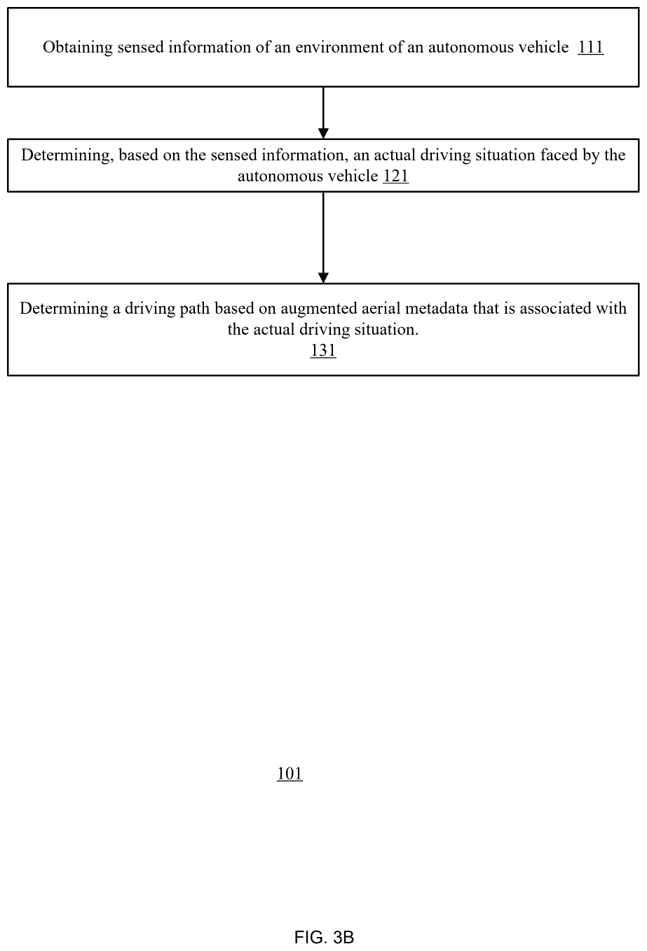

FIG. 3A illustrates an example of method 100.

According to an embodiment, method 100 is for simulation enhanced data augmentation from air for autonomous driving.

According to an embodiment, method 100 includes step 110 of obtaining sensed aerial information of a region of view containing multiple ground vehicles and road objects.

According to an embodiment, step 110 includes at least one of receiving the entire sensed aerial information, sensing the entire sensed aerial information, receiving at least some of the sensed aerial information and/or sensing at least some of sensed aerial information.

According to an embodiment the sensed aerial information includes one or more aerial information units. An aerial information unit can pertain to one or more aerial images and/or one or more video segments, captured by aerial sensors of an aerial system, or aerial vehicle, and the like. According to an embodiment, one or more aerial information units are acquired by one or more aerial sensors such as a satellite, a drone, manned airplanes, manned or an unmanned aerial vehicle, aerial military equipment, aerial commercial equipment, and others.

According to an embodiment, an aerial information unit may be of any wavelength for example, the aerial information unit may be a visual light aerial information unit, a monochromatic aerial information unit, a radar aerial information unit, an infrared aerial information unit, a thermal aerial information unit, a near infrared aerial information unit, and the like.

According to an embodiment, one or more aerial information units capture driving behaviors of at least 10, 100, 200, 500, 1000, 2000 road users, such as vehicles, per minute.

According to an embodiment, one or more aerial information units cover an area that ranges between 50 and 10,000,000 square meters.

According to an embodiment, one or more aerial information units are acquired from heights that range between tens of meters and ten thousands of kilometers. For example—an aerial information unit may be captured by geostationary satellites that are placed at an altitude of around 35786 kilometers.

According to an embodiment, different aerial information units are captured by different types of aerial sensors and the processing of the aerial information includes sensor fusion.

According to an embodiment, step 110 is followed by step 120 of analyzing the sensed aerial information, in accordance with a first identified driving scenario, to provide real-world profiling of road players in the first identified driving scenario.

According to an embodiment a driving scenario incorporates multiple aspects of and metrics affecting implementation of a model for autonomous driving, including for example a location of the vehicle, one or more weather conditions, one or more contextual parameters, road condition, traffic parameter(s). Various examples of a road condition may include the roughness of the road, the maintenance level of the road, presence of potholes or other related road obstacles, whether the road is slippery, covered with snow or other particles. Various examples of a traffic parameter and the one or more contextual parameters may include time (hour, day, period or year, certain hours at certain days, and the like), a traffic load, a distribution of vehicles on the road, the behavior of one or more vehicles (aggressive, calm, predictable, unpredictable, and the like), the presence of pedestrians near the road, the presence of pedestrians near the vehicle, the presence of pedestrians away from the vehicle, the behavior of the pedestrians (aggressive, calm, predictable, unpredictable, and the like), risk associated with driving within a vicinity of the vehicle, complexity associated with driving within of the vehicle, the presence (near the vehicle) of at least one out of a kindergarten, a school, a gathering of people, and the like. A contextual parameter may be related to the context of the sensed information—context may be depending on or relating to the circumstances that form the setting for an event, statement, or idea.

An identified driving scenario is a known driving scenario.

According to an embodiment, step 120 is followed by step 130 of generating, based on the analyzing, by simulation of different road players (for example different road players with corresponding real-world profiling—having their profile learnt or known otherwise), simulated aerial information containing simulated behavioral information pertaining to the road players in the first identified driving scenario.

According to an embodiment, step 130 is followed by step 140 of augmenting the sensed information by adding the simulated aerial information, to produce augmented aerial information in association with the first identified driving scenario.

According to an embodiment, step 140 is followed by step 150 of providing the augmented aerial information, for use in autonomous driving. The providing may include storing, transmitting, tagging as a training dataset, and the like.

According to an embodiment, at least one of the analyzing, generating, augmenting and the producing is executed by a machine learning process.

According to an embodiment, method 100 includes step 160 of producing respective ground views from the augmented aerial information.

According to an embodiment the respective ground views are related to two or more ground vehicle captured by the sensed aerial information.

According to an embodiment, a conversion from aerial information to ground view may be provided by a machine learning process trained to perform such a conversion. An example of such a mapping is illustrated in U.S. patent application Ser. No. 18/527,701 titled “ PERCEPTION BASED DRIVING/ZERO SHOT LOCALIZATION FOR AUTONOMOUS DRIVING” which is incorporated herein by reference in its entirety.

According to an embodiment, the machine learning process is trained by providing to the machine learning network aerial information and ground view information related to the same events.

According to an embodiment, the machine learning process is trained using a supervised training or another training process.

According to an embodiment, the conversion includes converting the augmented aerial information to type of information shared by the augmented aerial information and the ground view and then processing the common format of information to provide the ground view.

According to an embodiment, the shared format of information may be selected out of kinematics information, movement information (including force information absent from kinematics information, behavioral information, and the like). The kinematic information (or movement information) is then converted to the ground view.

According to an embodiment, step 160 is followed by step 170 of creating respective training sets for artificial intelligence models.

Different training sets may be associated with different road segments or with different identified driving scenarios or with different combination of road segment and identified driving scenarios.

According to an embodiment, step 170 is followed by step 180 of training the artificial intelligence models using the training sets.

According to an embodiment, step 140 of augmenting is per given road segment of the region of view, and the training of the artificial intelligence models is per given road segment.

While the previous text related to a first identified driving scenario, method 100 is applicable to one or more additional identified driving scenarios—for example to a second identified driving scenario.

According to an embodiment the same sensed aerial information is processed in relation to different identified scenarios.

According to an embodiment, there is only a partial overlap or no overlap between sensed aerial information being processed in relation to different identified driving scenarios.

According to an embodiment, one or more steps of method 100 are executed, in relation to two or more identified scenarios, in parallel to each other or in a serial manner one after the other.

According to an embodiment, at least steps 120, 130, 140 and 150 are repeated in relation to a second identified driving scenario or in relation to two or more additional identified scenarios.

According to an embodiment, at least step 140 is applied with respect to the second identified driving scenario, to produce additional augmented aerial information in association with the second identified driving scenario.

According to an embodiment, step 120 includes analyzing corresponding sensed information pertaining to a second identified driving scenario, and step 140 includes augmenting, based on the analyzing, the corresponding sensed information by adding at least a portion of the simulated aerial information, to produce additional augmented aerial information in association with the second identified driving scenario.

According to an embodiment, the corresponding sensed information is of an additional region of view.

According to an embodiment, method 100 includes obtaining the corresponding sensed information by obtaining additional sensed information in accordance with the second identified driving scenario.

According to an embodiment, the corresponding sensed information includes at least a portion of the sensed information, in accordance with the first identified driving scenario.

FIG. 3B illustrates an example of method 101 for planning a progress of an autonomous vehicle.

According to an embodiment, method 101 includes step 111 of obtaining sensed information of an environment of an autonomous vehicle.

According to an embodiment, step 111 is followed by step 121 of determining, based on the sensed information, an actual driving situation faced by the autonomous vehicle.

According to an embodiment, step 121 is followed by step 131 of determining a driving path based on augmented aerial metadata that is associated with the actual driving situation.

According to an embodiment, step 131 is executed by a machine learning process trained using the augmented aerial information associated with a reference driving scenario that is similar (or the same) as the actual driving situation—wherein the augmented aerial information is generated by generated by method 100 of FIG. 3A.

Steps 121 and 131 may include applying a signature based detection of an actual situation and autonomously driving an autonomous vehicle based on a situation—as is illustrated for example, in U.S. Pat. No. 12,128,927 which is incorporated herein by reference.

Step 131 of determining the driving pay may include controlling an aspect of driving a vehicle based on a detection of a scene and how vehicle behaved when facing the scene. An example of controlling an aspect of driving a vehicle based on a detection of a scene and how vehicle behaved when facing the scene—for example at a school zone—is illustrated in U.S. Pat. No. 11,897,497 which is incorporated herein by reference. While said patent refers to a school zone its teaches can be applied mutatis mutandis to any other driving scenarios.

According to an embodiment, the training providing the augmented aerial information and also ego vehicle behavioral information that defines a manner in which an ego vehicle is driven at the presence of road players associated with the reference driving scenario. It should be noted that the augmentation may enrich the reference driving scenario with one or more virtual road players—so that referring to ego vehicle driving at the presence of road players may provide an answer even to augmented driving scenarios.

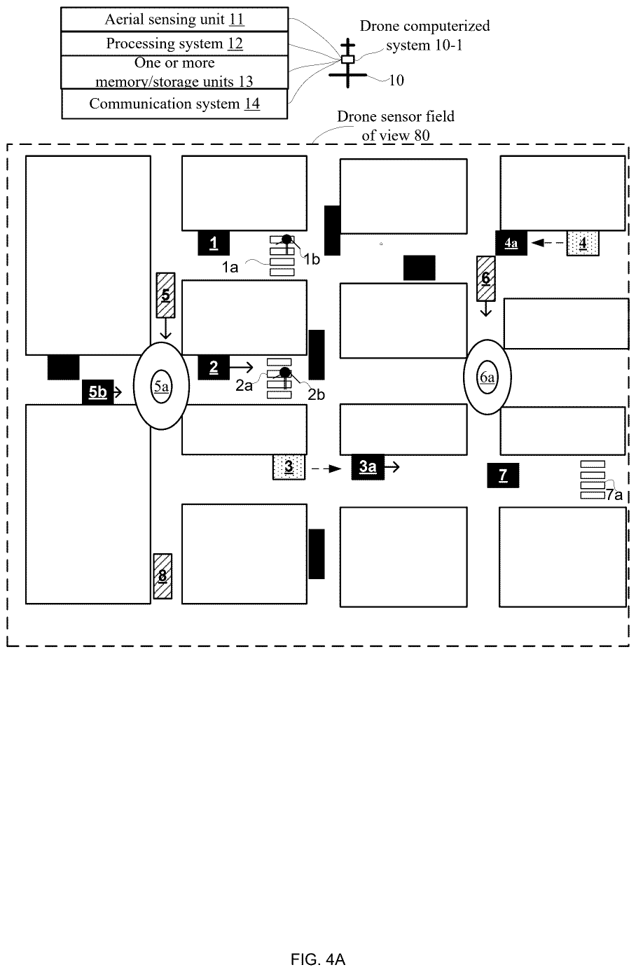

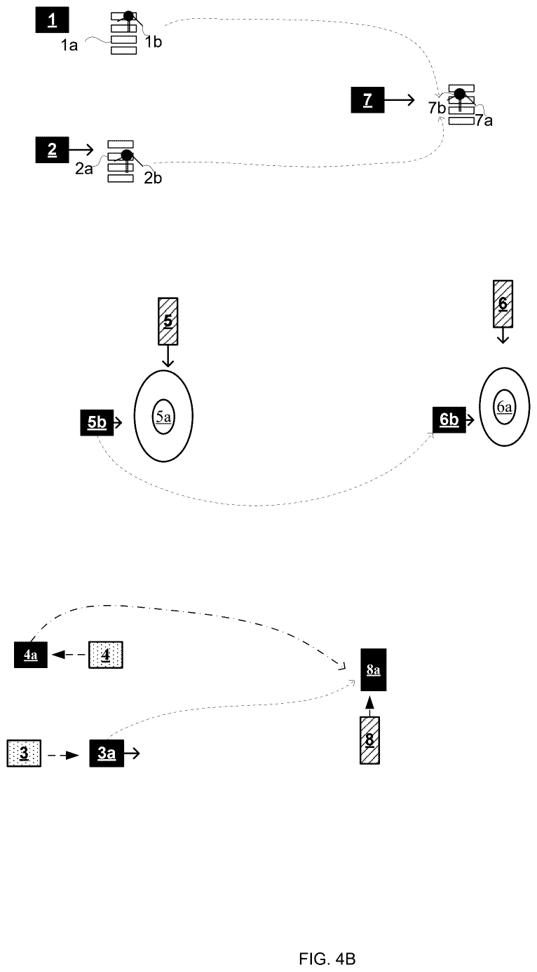

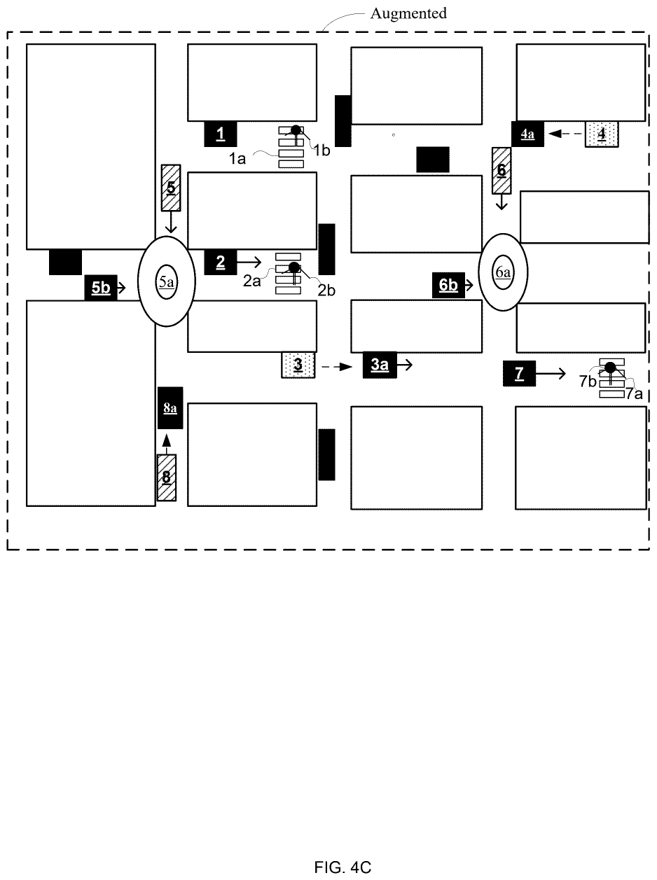

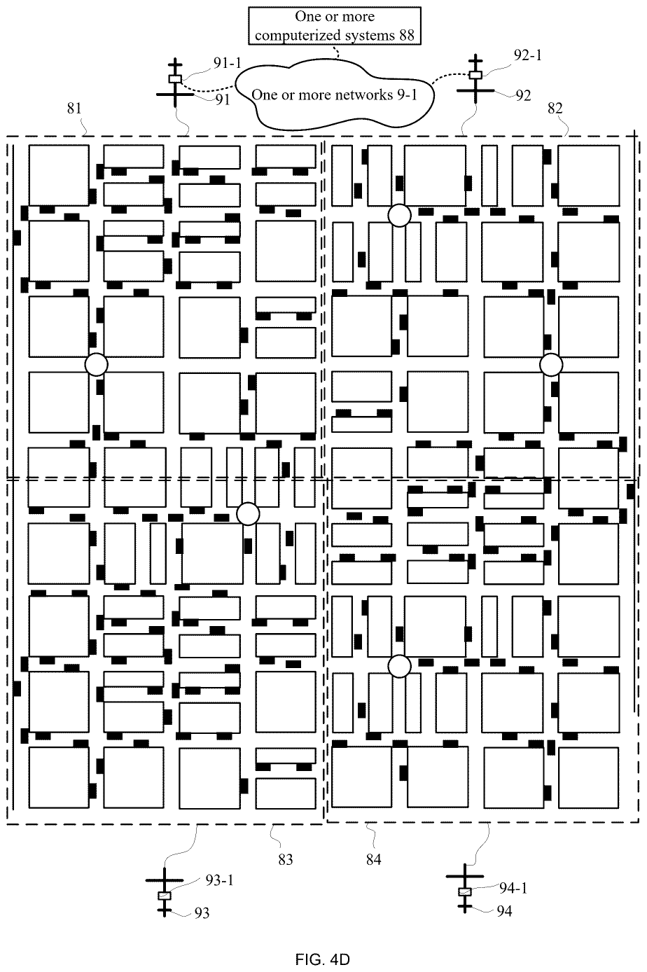

FIG. 4A illustrates an example of an aerial system such as a drone 10, and a drone sensor field of view 80 used for acquiring a sensed aerial image. The drone 10 includes a drone computerized system 10-1 that includes an aerial sensing unit 11 for acquiring the sensed aerial image, a processing system 12 for at least initially processing the sensed aerial image, one or more memory/storage system for storing instructions and/or the sensed aerial image, and a communication system 14 for communicating with systems outside the drone—such as computerized system 400 of FIG. 1 and/or vehicle 300 of FIG. 2.

A sensed aerial image such that corresponds to the drone field of view captures multiple ground vehicles within an urban environment. In figure aerial information associated with three identified driving scenarios are captured:
First driving scenario—a vehicle that reaches a crossroad while a pedestrian crosses the crossroad.
   i. A first instance of the first driving scenario involves first vehicle 1, first crossroad 1a and a first pedestrian 1b crossing the first crossroad.
   ii. A second instance of the first driving scenario involves second vehicle 2, second crossroad 12 and a second pedestrian 12 crossing the second crossroad.
Second driving scenario—a vehicle follows another vehicle that drives on the same lane and direction of the vehicle.
   i. A first instance of the second driving scenario involves third vehicle 3 that follows third next vehicle 3a.
   ii. A second instance of the second driving scenario involves fourth vehicle 4 that follows fourth next vehicle 4a.
Third driving scenario—a vehicle that reaches a roundabout from a first direction when another vehicle reaches the roundabout from a perpendicular direction.
i. A first instance of the third driving scenario involves fifth vehicle 5 that reaches first roundabout 5a from a first direction while another vehicle 5b reaches the first roundabout from a perpendicular direction.

FIG. 4A also illustrates seventh vehicle 7 that faces third crossroad 7a, sixth vehicle 6 being the only vehicle that reaches the second roundabout 6a, and eighth vehicle 8 being the only vehicle within a certain road portion.

FIG. 4B illustrates how to augment the aerial information of FIG. 4A—based on instances of the first, second and third driving scenarios.
Based on the first instance and the second instance of the first driving scenario—the aerial image is augmented by having a virtual pedestrian 7b cross third crossroad 7a. The virtual pedestrian 7b behaves according to the behavior of the first and second pedestrians 1b and 2b that crossed the first and second crossroads 1a and 2a respectively.
Based on the first and second instances of the second driving scenario—a virtual vehicle 8a is added in front the eighth vehicle 8. The virtual vehicle 8a behaves according to the behavior of the third next vehicle 3a and the fourth next vehicle 4a.
Based on the first instance of the third driving scenario—the aerial is augmented by having a virtual vehicle 6b reach the second roundabout 6a from a direction perpendicular to the direction of the sixth vehicle.

While various examples refer to adding a virtual road player—the augmenting may include changing a behavior of a road player captured in the aerial information and/or removing one or more road player captured in the aerial information.

FIG. 4C illustrates the augmented aerial image—that includes the content of the sensed aerial image from FIG. 4A and the augmented information from FIG. 4B.

As indicated about—the aerial information may be obtained based on aerial information that covers more than a single region.

FIG. 4D illustrates an example of one or more computerized systems 88, one or more networks 9-1, aerial systems 91, 92, 93 and 94 having aerial computerized systems 91-1, 91-2, 91-3 and 91-4 respectively and fields of views 81, 82, 83 and 94, respectively.

Content from an aerial image from one of the drones may be used to augment an aerial image taken from another drone.

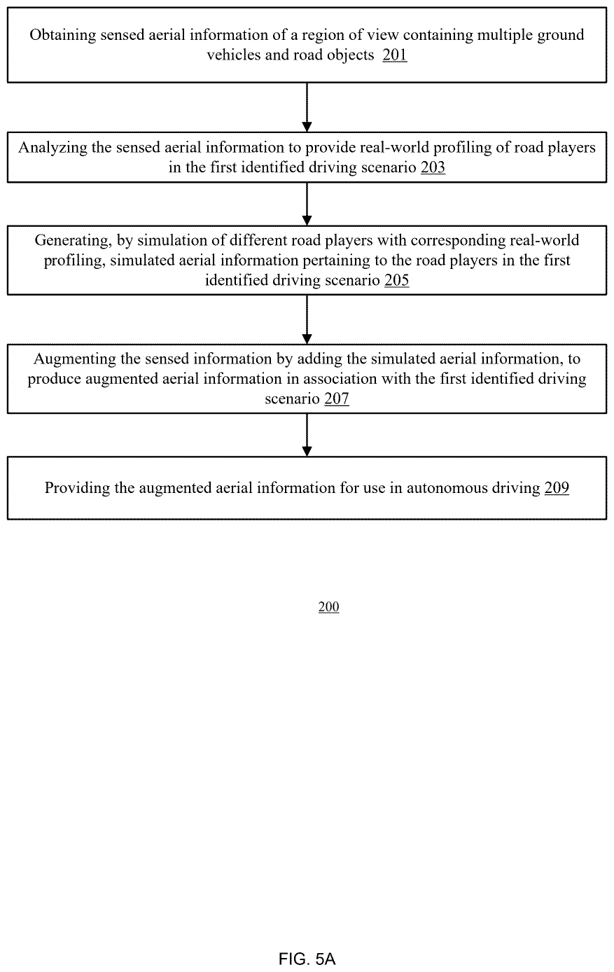

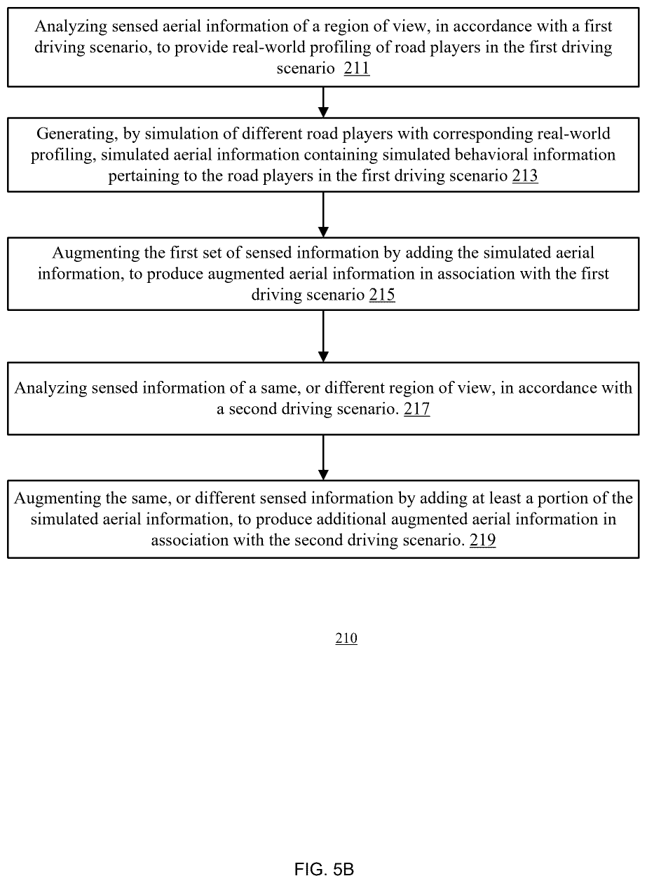

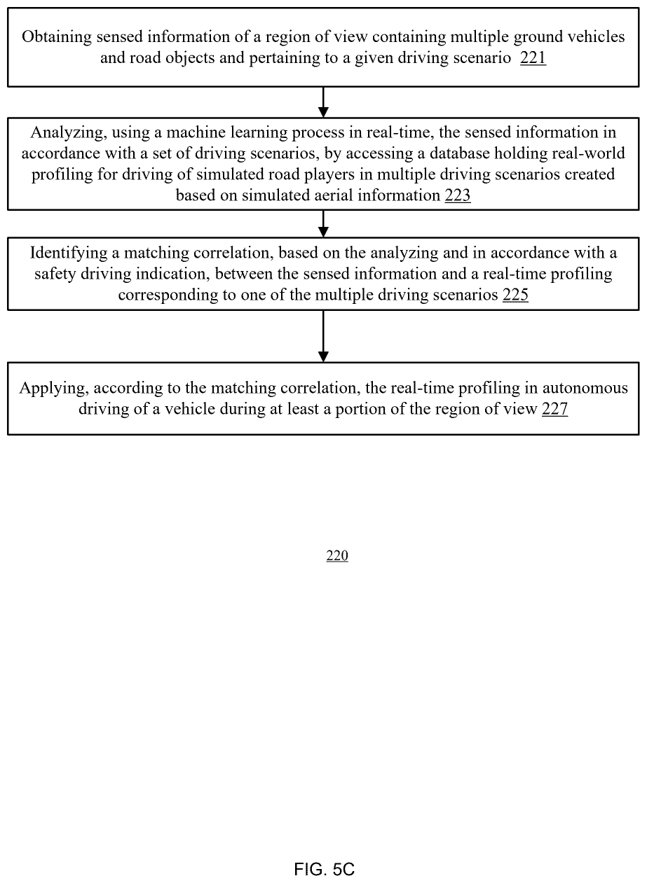

FIG. 5A illustrates an example of method 200.

According to an embodiment, method 200 includes step 201 of obtaining sensed aerial information of a region of view containing multiple ground vehicles and road objects.

According to an embodiment, step 201 is followed by step 203 of analyzing the sensed aerial information, in accordance with a first identified driving scenario, to provide real-world profiling of road players in the first identified driving scenario. The profiling includes building profiles of road players that at least define the behaviors of the road players—including for example typical behaviors (or a typical behaviors), typical times of following the typical behaviors, acceleration and/or speed and/or change or direction associated with the typical behavior.

According to an embodiment, step 203 is followed by step 205 of generating, by simulation of different road players with corresponding real-world profiling, simulated aerial information containing simulated behavioral information pertaining to the road players in the first identified driving scenario.

According to an embodiment, step 205 is followed by step 207 of augmenting the sensed information by adding the simulated aerial information, to produce augmented aerial information in association with the first identified driving scenario.

According to an embodiment, step 207 is followed by step 209 of providing the augmented aerial information for use in autonomous driving.

FIG. 5B illustrates an example of method 210.

According to an embodiment, method 210 includes step 211 of analyzing sensed aerial information of a region of view, in accordance with a first driving scenario, to provide real-world profiling of road players in the first driving scenario.

According to an embodiment, step 211 is followed by step 213 of generating, by simulation of different road players with corresponding real-world profiling, simulated aerial information containing simulated behavioral information pertaining to the road players in the first driving scenario.

According to an embodiment, step 213 is followed by step 215 of augmenting the first set of sensed information by adding the simulated aerial information, to produce augmented aerial information in association with the first driving scenario.

According to an embodiment, step 215 is followed by step 217 of analyzing sensed information of a same, or different region of view, in accordance with a second driving scenario.

According to an embodiment, step 217 is followed by step 219 of augmenting the same, or different sensed information by adding at least a portion of the simulated aerial information, to produce additional augmented aerial information in association with the second driving scenario.

FIG. 5B illustrates an example of method 220.

According to an embodiment, method 220 includes step 221 of obtaining sensed information of a region of view containing multiple ground vehicles and road objects and pertaining to a given driving scenario.

According to an embodiment, step 221 is followed by step 223 of analyzing, using a machine learning process in real-time, the sensed information in accordance with a set of driving scenarios, by accessing a database holding real-world profiling for driving of simulated road players in multiple driving scenarios created based on simulated aerial information.

According to an embodiment, step 223 is followed by step 225 of identifying a matching correlation, based on the analyzing and in accordance with a safety driving indication, between the sensed information and a real-time profiling corresponding to one of the multiple driving scenarios.

According to an embodiment, step 225 is followed by step 227 of applying, according to the matching correlation, the real-time profiling in autonomous driving of a vehicle during at least a portion of the region of view.

According to an embodiment there is provided a method for planning a progress of an autonomous vehicle.

According to an embodiment there is provided a method for planning a progress of an autonomous vehicle, the method includes (a) obtaining sensed information of an environment of a vehicle; (b) determining, based on the sensed information, an actual situation faced by the vehicle; (c) analyzing, by using a machine learning process in real-time during inference, the actual situation sensed information across a set of multiple reference situations, by searching in a database holding for each reference situation out of the multiple reference situations, reference situation information comprising behavioral information pertaining to road players during the situation, wherein database is built based on simulated aerial information pertaining to simulated road players in multiple situations; identifying, based on the analyzing, one or more matching reference situations of the multiple reference situations that correspond to the actual situation; (d) determining a driving pattern, based on the identifying; and (e) providing the driving pattern, for use in autonomous driving of the vehicle.

According to an embodiment, the identifying is by using a signature.

According to an embodiment, the includes verifying the determined driving pattern in accordance with the sensed information.

According to an embodiment, the providing the driving pattern is contingent on an outcome of the verifying.

According to an embodiment, the analyzing is per a given road segment of the environment.

According to an embodiment, the providing the driving pattern includes providing an indication with respect to a driving action, based on the determining.

According to an embodiment, the indication is a control action to imitate a driving behavior, based on the behavioral information of a corresponding reference situation information.

According to an embodiment, the analyzing is in accordance with a respective ground view of the vehicle.

According to an embodiment there is provided a non-transitory computer readable medium for planning a progress of an autonomous vehicle, the non-transitory computer readable medium storing instructions that, when executable by at least one processing device, causes the processing device to: (a) obtain sensed information of an environment of a vehicle; (b) determine, based on the sensed information, an actual situation faced by the vehicle; (c) analyze, by using a machine learning process in real-time during inference, the actual situation sensed information across a set of multiple reference situations, by searching in a database holding for each reference situation out of the multiple reference situations, reference situation information comprising behavioral information pertaining to road players during the situation, wherein database is built based on simulated aerial information pertaining to simulated road players in multiple situations; (d) identify, based on the analyzing, one or more matching reference situations of the multiple reference situations that correspond to the actual situation; and (e) determine a driving pattern, based on the identifying, for use in autonomous driving of the vehicle.

According to an embodiment, the identifying is by using a signature.

According to an embodiment, the non-transitory computer readable medium stores instructions for verifying the determined driving pattern in accordance with the sensed information.

According to an embodiment, the providing the driving pattern is contingent on an outcome of the verifying.

According to an embodiment, the analyzing is per a given road segment of the environment.

According to an embodiment, the providing the driving pattern includes providing an indication with respect to a driving action, based on the determining.

According to an embodiment, the indication is a control action to imitate a driving behavior, based on the behavioral information of a corresponding reference situation information.

According to an embodiment, the analyzing is in accordance with a respective ground view of the vehicle.

According to an embodiment, there is provided a system for planning a progress of an autonomous vehicle, comprising: a memory configured to store aerial images containing sensed information of an environment of a vehicle; and a processor configured to: analyze, by using a machine learning process in real-time during inference, the actual situation sensed information across a set of multiple reference situations, by searching in a database holding for each reference situation out of the multiple reference situations, reference situation information comprising behavioral information pertaining to road players during the situation, wherein database is built based on simulated aerial information pertaining to simulated road players in multiple situations; identify, based on the analyzing, one or more matching reference situations of the multiple reference situations that correspond to the actual situation; and determine a driving pattern, based on the identifying, for use in autonomous driving of the vehicle.

According to an embodiment, the processor is further configured to verify the determined driving pattern in accordance with the sensed information.

According to an embodiment, the providing the driving pattern is contingent on an outcome of the verifying.

According to an embodiment, the analyzing is per a given road segment of the environment.

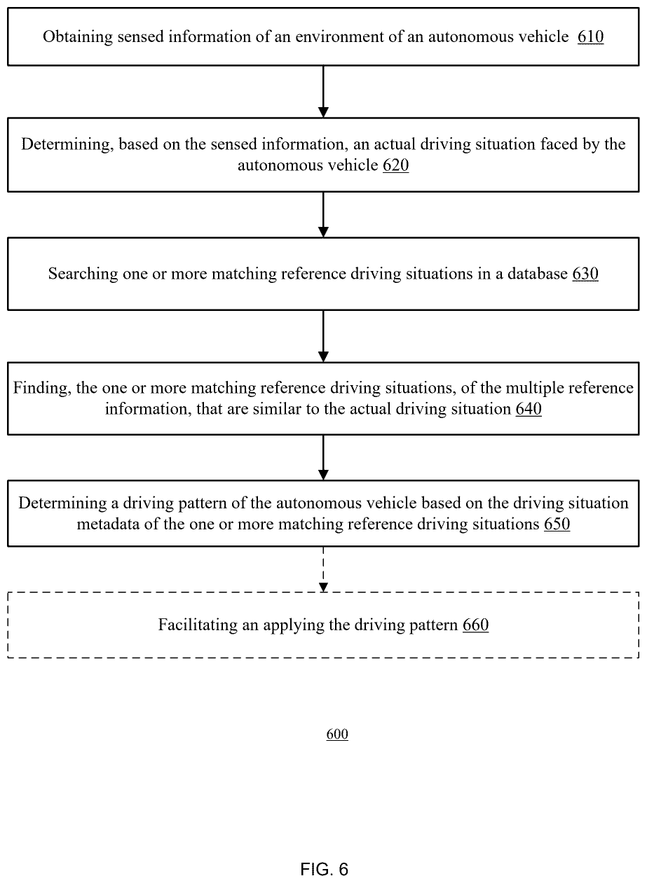

FIG. 6 illustrates an example of method 600 for planning a progress of an autonomous vehicle based on a database.

According to an embodiment, method 600 includes step 610 of obtaining sensed information of an environment of an autonomous vehicle.

According to an embodiment, step 610 is followed by step 620 of determining, based on the sensed information, an actual driving situation faced by the autonomous vehicle.

According to an embodiment, step 620 is followed by step 630 of searching one or more matching reference driving situations in a database. The database includes, for each reference driving situation out of multiple reference driving situations, reference driving situation metadata.

The reference driving situation metadata of a situation includes reference driving situation content information that identifies a content of the reference driving situation.

According to an embodiment the reference driving situation metadata of a situation also include reference driving situation behavioral information that defines a behavior of road players during the driving situation.

According to an embodiment, the reference driving situation metadata of a situation also include reference driving situation ego vehicle behavioral information that defines a manner in which an ego vehicle is driven at the presence of road players during the driving situation.

The database is built based on aerial information and on simulated information that adds one or more simulated road players to one or more driving situations based on a probability of appearance of the one or more road players at the one or more driving situations.

According to an embodiment, the adding may include finding that although a sensed information regarding a defined reference situation still does not capture a presence and/or a behavior of a road player—that in similar reference situations (for example references situations that merely differ by their location) the presence and/or the behavior of a road player was captured—and that at a probability that exceeds at least a defined threshold—it will appear in the defined reference situation. Examples of such additional are provided in FIG. 4B.

According to an embodiment, step 630 is followed by step 640 of finding, the one or more matching reference driving situations, of the multiple reference information, that are similar to the actual driving situation.

The similarity is sought between the reference driving situation content information and an actual driving situation content information. The content information may be an embedding, a signature of an embedding, a signature, and the like. Similarity—may be determined by any defined mathematical criterion—for example having a distance within a multi-dimensional space that does not exceed a defined threshold.

According to an embodiment, step 640 is followed by step 650 of determining a driving pattern of the autonomous vehicle based on the driving situation metadata of the one or more matching reference driving situations.

According to an embodiment, the driving situation metadata defined which one or more road players are expected to impact the vehicle (which one or more road players are expected to be close enough to introduce a change in the driving of the vehicle—and how they are expected to behave—how do they progress (speed, direction acceleration), and the like.

According to an embodiment, there are multiple matching reference driving situations and the driving pattern may be defined to cope with the most impacting or most dangerous road player out of the road players that appear in any of the multiple matching reference driving situations. Most impacting—for example the road player that will required the vehicle to progress at the slowest speed and/or a road player that has the most unpredictable behavior and may force the vehicle to abruptly changes it progress, and the like.

According to an embodiment, the reference driving situation metadata of a situation also include reference driving situation ego vehicle behavioral information that defines a manner in which an ego vehicle is driven at the presence of road players during the driving situation.
In this case, the determining of the driving pattern of the autonomous vehicle is based on the reference driving situation ego vehicle behavioral information of the one or more matching reference driving scenarios.
If there are matching reference driving scenarios then step 650 may include selecting the safest driving pattern (for example the slowest) out of those of the matching reference driving scenarios.

According to an embodiment, step 650 is followed by step 660 of facilitating in applying the driving pattern.

According to an embodiment, step 660 include generating a driving related decision and/or implementing the driving related decision.

At least step 650 and 660 may be applied using the teaching of at least one patent out of U.S. Pat. No. 12,128,927 which is incorporated herein by reference, and/or U.S. Pat. No. 11,897,497 which is incorporated herein by reference. While said patent refers to a school zone its teaching can be applied mutatis mutandis to any other driving scenarios.

According to an embodiment, the driving related decision is converted to instructions and/or commands and/or requests to move the autonomous vehicle according to the driving pattern.

According to an embodiment, the driving related decision includes instructions and/or commands and/or requests to move the autonomous vehicle according to the driving pattern.

According to an embodiment, any driving related decision generated by any computerized system (either included in the ground vehicle copilot or not) may include or may be converted to (by a computerized system of the ground vehicle or by another computerized system) a request and/or a determining of an instruction and/or an instruct and/or a trigger and/or a control of and/or a performance of an autonomous driving related operation of the ground vehicle. The driving related decision may be related to a velocity and/or acceleration and/or direction of movement of the ground vehicle at one or more points in time. According to an embodiment, the driving related decision is aimed to one or more ground vehicle components such as brakes, clutch, engine, gear, or any other component that sets the velocity and/or acceleration and/or direction of movement of the ground vehicle.

According to an embodiment, any driving related decision generated by any computerized system is in compliant with one or more levels of autonomous driving—such as L2, L2+, L2++, L3 or L4 autonomous driving.

According to an embodiment there is provided a method of simulation enhanced data augmentation from air for autonomous driving, the method includes obtaining sensed aerial information of a region of view containing multiple ground vehicles and road objects; analyzing the sensed aerial information, in accordance with a first identified driving scenario, to provide real-world profiling of road players in the first identified driving scenario; generating, based on the analyzing by simulation of different road players with corresponding real-world profiling, simulated aerial information containing simulated behavioral information pertaining to the road players in the first identified driving scenario; augmenting the sensed information by adding the simulated aerial information, to produce augmented aerial information in association with the first identified driving scenario; and providing the augmented aerial information, for use in autonomous driving, wherein at least one of the analyzing, generating, and the augmenting is executed by a machine learning process.

According to an embodiment, the producing the respective ground views includes creating respective training sets for artificial intelligence models.

According to an embodiment, the method includes training the artificial intelligence models using the training sets.

According to an embodiment, the augmenting is per given road segment of the region of view, and the training of the artificial intelligence models is per given road segment.

According to an embodiment, at least the augmenting is applied with respect to a second identified driving scenario, to produce additional augmented aerial information in association with the second identified driving scenario.

According to an embodiment, the method includes analyzing corresponding sensed information in accordance with a second identified driving scenario; and augmenting, based on the analyzing, the corresponding sensed information by adding at least a portion of the simulated aerial information, to produce additional augmented aerial information in association with the second identified driving scenario.

According to an embodiment, the corresponding sensed information is of an additional region of view.

According to an embodiment, the method includes producing, based on the augmenting, respective ground views each from a respective point of view of a different ground vehicle and including augmented road object information pertaining to the respective point of view of each different ground vehicle.

According to an embodiment there is provided a non-transitory computer readable medium for simulation enhanced data augmentation from air for autonomous driving, the non-transitory computer readable medium storing instructions that, when executable by at least one processing device, causes the processing device to obtain sensed aerial information of a region of view containing multiple ground vehicles and road objects; analyze, by using a machine learning process, the sensed aerial information in accordance with a first identified driving scenario, to provide real-world profiling of road players in the first identified driving scenario; generate, based on the analyzing by simulation of different road players with corresponding real-world profiling, simulated aerial information containing simulated behavioral information pertaining to the road players in the first identified driving scenario; augment the sensed information by adding the simulated aerial information, to produce augmented aerial information in association with the first identified driving scenario; and provide the augmented aerial information, for use in autonomous driving.

According to an embodiment, the stored instructions cause the processing device to produce the respective ground views by creating respective training sets for artificial intelligence models.

According to an embodiment, the stored instructions cause the processing device to train the artificial intelligence models using the respective training sets.

According to an embodiment, the stored instructions cause the processing device to augment the sensed information per a given road segment of the region of view, and to train the artificial intelligence models per the given road segment.

According to an embodiment, the non-transitory computer readable medium is storing instructions, that when executable by the at least one processing device, cause the processing device to augment the sensed information in accordance with a second identified driving scenario; and
produce, based on the augmenting, corresponding augmented aerial information for use in autonomous driving with respect to the second identified driving scenario.

According to an embodiment, the non-transitory computer readable medium is storing instructions, that when executable by the at least one processing device, cause the processing device to analyze corresponding sensed information in accordance with a second identified driving scenario; augment, based on the analyzing, the corresponding sensed information by adding at least a portion of the simulated aerial information; and produce additional augmented aerial information in association with the second identified driving scenario.

According to an embodiment, the corresponding sensed information is of an additional region of view.

According to an embodiment, the non-transitory computer readable medium is storing instructions, that when executable by the at least one processing device, cause the processing device to produce, based on the augmenting, respective ground views each from a respective point of view of a different ground vehicle, wherein each respective ground view include augmented road object information pertaining to the respective point of view of a respective ground vehicle.

According to an embodiment there is provided a system for simulation enhanced data augmentation from air for autonomous driving, includes a memory configured to store aerial images containing aerial data of a region containing multiple ground vehicles and road objects; and a processor configured to analyze, in a machine learning process, the sensed aerial information in accordance with a first identified driving scenario, to provide real-world profiling of road players in the first identified driving scenario; generate, based on the analyzing by simulation of different road players with corresponding real-world profiling, simulated aerial information containing simulated behavioral information pertaining to the road players in the first identified driving scenario; augment the sensed information by adding the simulated aerial information, to produce augmented aerial information in association with the first identified driving scenario; and provide the augmented aerial information, for use in autonomous driving.

According to an embodiment, producing the respective ground views includes creating respective training sets for artificial intelligence models.

According to an embodiment, the processor is configured to train the artificial intelligence models using the training sets.

According to an embodiment, the processor is configured to analyze corresponding sensed information in accordance with a second identified driving scenario; and augment, based on the analyzing, the corresponding sensed information by adding at least a portion of the simulated aerial information, to produce additional augmented aerial information in association with the second identified driving scenario.

Because some aspects of the illustrated embodiments of the present disclosure may, for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any combination of any steps of any method illustrated in the specification and/or drawings may be provided. Any combination of any subject matter of any of claims may be provided. Any combinations of systems, units, components, processors, sensors, illustrated in the specification and/or drawings may be provided. Any combination of any module or unit listed in any of the figures, any part of the specification and/or any claims may be provided.

Any reference in the specification to a method should be applied mutatis mutandis to a device or system capable of executing the method and/or to a non-transitory computer readable medium that stores instructions for executing the method. Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

In the foregoing specification, the invention has been described with reference to specific examples of embodiments of the invention. It will, however, be evident that various modifications and changes may be made therein without departing from the broader spirit and scope of the invention as set forth in the appended claims. The specifications and drawings are, accordingly, to be regarded in an illustrative rather than in a restrictive sense.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of the underlying architecture or intermedial components. Likewise, any two components so associated can also be viewed as being “operably connected,” or “operably coupled,” to each other to achieve the desired functionality.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Thus, the scope of the embodiments of the disclosure is defined by the appended claims and equivalents thereof. While certain features of the disclosure have been illustrated and described herein, many modifications, substitutions, changes, and equivalents will now occur to those of ordinary skill in the art. It is therefore to be understood that the appended claims are intended to cover all such modifications and changes as fall within the true spirit of the invention.

We claim

1. According to an embodiment there is provided a method for determining driving patterns for mixed real-world driving scenarios, the method comprises:
obtaining sensed information of an environment of a vehicle;
determining, based on the sensed information, an actual situation faced by the vehicle;
analyzing, by using a machine learning process in real-time during inference, the actual situation sensed information across a set of multiple reference situations, by searching in a database holding for each reference situation out of the multiple reference situations, reference situation information comprising behavioral information pertaining to road players during the situation, wherein database is built based on simulated aerial information pertaining to simulated road players in multiple situations; identifying, based on the analyzing, one or more matching reference situations of the multiple reference situations that correspond to the actual situation;
determining a driving pattern, based on the identifying; and
providing the driving pattern, for use in autonomous driving of the vehicle.

2. The method according to claim 1, wherein the identifying is by using a signature.

3. The method according to claim 1, wherein the method comprises verifying the determined driving pattern in accordance with the sensed information.

4. The method according to claim 1, wherein the providing the driving pattern is contingent on an outcome of the verifying.

5. The method according to claim 1, wherein the analyzing is per a given road segment of the environment.

6. The method according to claim 1, wherein the providing of the driving pattern includes providing an indication with respect to a driving action, based on the determining.

7. The method according to claim 1, wherein the indication is a control action to imitate a driving behavior, based on the behavioral information of a corresponding reference situation information.

8. The method according to claim 1, wherein the analyzing is in accordance with a respective ground view of the vehicle.

9. A non-transitory computer readable medium for determining driving patterns for mixed real-world and simulated driving scenarios, the non-transitory computer readable medium storing instructions that, when executable by at least one processing device, causes the processing device to:
obtain sensed information of an environment of a vehicle;
determine, based on the sensed information, an actual situation faced by the vehicle;
analyze, by using a machine learning process in real-time during inference, the actual situation sensed information across a set of multiple reference situations, by searching in a database holding for each reference situation out of the multiple reference situations, reference situation information comprising behavioral information pertaining to road players during the situation, wherein database is built based on simulated aerial information pertaining to simulated road players in multiple situations;
identify, based on the analyzing, one or more matching reference situations of the multiple reference situations that correspond to the actual situation; and
determine a driving pattern, based on the identifying, for use in autonomous driving of the vehicle.

10. The non-transitory computer readable medium according to claim 9, wherein the identifying is by using a signature.

11. The non-transitory computer readable medium according to claim 9, wherein the non-transitory computer readable medium stores instructions for verifying the determined driving pattern in accordance with the sensed information.

12. The non-transitory computer readable medium according to claim 9, wherein the providing the driving pattern is contingent on an outcome of the verifying.

13. The non-transitory computer readable medium according to claim 9, wherein the analyzing is per a given road segment of the environment.

14. The non-transitory computer readable medium according to claim 9, wherein the providing the driving pattern includes providing an indication with respect to a driving action, based on the determining.

15. The non-transitory computer readable medium according to claim 9, wherein the indication is a control action to imitate a driving behavior, based on the behavioral information of a corresponding reference situation information.

16. The non-transitory computer readable medium according to claim 9, wherein the analyzing is in accordance with a respective ground view of the vehicle.

17. A system of determining driving patterns for mixed real-world and simulated driving scenarios, comprising:
a memory configured to store aerial images containing sensed information of an environment of a vehicle; and
a processor configured to:
analyze, by using a machine learning process in real-time during inference, the actual situation sensed information across a set of multiple reference situations, by searching in a database holding for each reference situation out of the multiple reference situations, reference situation information comprising behavioral information pertaining to road players during the situation, wherein database is built based on simulated aerial information pertaining to simulated road players in multiple situations; identify, based on the analyzing, one or more matching reference situations of the multiple reference situations that correspond to the actual situation; and
determine a driving pattern, based on the identifying, for use in autonomous driving of the vehicle.

18. The system according to claim 17, wherein the processor is further configured to verify the determined driving pattern in accordance with the sensed information.

19. The system according to claim 17, wherein the providing the driving pattern is contingent on an outcome of the verifying.
